(19) United States
(12) Patent Application Publication
(10) Pub. No.: US 2026/0179843 A1
(43) Pub. Date: Jun. 25, 2026

(54) MULTILAYER ELECTRONIC COMPONENT

(71) Applicant: SAMSUNG ELECTRO-MECHANICS CO., LTD., Suwon-si (KR)

(72) Inventors: Ji Hyun LEE, Suwon-si (KR); Jong Hoon YOO, Suwon-si (KR)

(73) Assignee: SAMSUNG ELECTRO-MECHANICS CO., LTD., Suwon-si (KR)

(21) Appl. No.: 19/381,149

(22) Filed: Nov. 6, 2025

(30) Foreign Application Priority Data
Dec. 19, 2024 (KR) 10-2024-0191097

(51) Int. Cl. H01G 4/224; H01G 4/12; H01G 4/232; H01G 4/248; H01G 4/30

(52) U.S. Cl. CPC H01G 4/224; H01G 4/12; H01G 4/232; H01G 4/248; H01G 4/30

(57) ABSTRACT

A multilayer electronic component according to an example embodiment of the present disclosure may include: a body including a capacitance formation portion including a dielectric layer and internal electrodes, and first and second surfaces opposing each other in the first direction, third and fourth surfaces opposing each other in the second direction, fifth and sixth surfaces opposing each other in the third direction; an external electrode disposed on each of the third and fourth surfaces; a side margin portion disposed on each of the fifth and sixth surfaces and including a plurality of dielectric crystal grains. For each of M cross-sections, in the first and third directions, of the side margin portion, when an average size of the plurality of dielectric crystal grains is measured in N regions, a standard deviation of average size values measured M×N times is 5.3 or more and 8.3 or less.

### CROSS-REFERENCE TO RELATED APPLICATION(S)

This application claims benefit of priority to Korean Patent Application No. 10-2024-0191097 filed on Dec. 19, 2024, in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-shaped capacitor mounted on the printed circuit boards of various types of electronic products such as video devices such as Liquid Crystal Display (LCD) and Plasma Display Panel (PDP), computers, smartphones and mobile phones, and the circuits of the onboard charger (OBC) DC-DC converter of electric vehicles, and the like, and playing a role in charging or discharging electricity.

In order to miniaturize and increase the capacitance of the MLCC, maximizing an effective area of an internal electrode is required. To this end, a method of maximizing a widthwise area of the internal electrode has been researched, and specifically, a method of separately attaching a sheet for forming a side margin to a widthwise cross-section of a stack chip before sintering and then sintering the sheet has been applied. Since the microstructure of the side margin has a significant impact on the reliability of the MLCC, additional research thereon is necessary.

### PRIOR ART REFERENCE

### Patent Document

(Patent Document 1) Korean Patent Publication No. 10-2015-0135092

### SUMMARY

An aspect of the present disclosure is to provide a highly reliable multilayer electronic component.

However, the aspects of the present disclosure are not limited to the above-described contents, and may be more easily understood in the process of describing specific embodiments of the present disclosure.

A multilayer electronic component according to an example embodiment of the present disclosure may include: a body including a capacitance formation portion including a dielectric layer and internal electrodes alternately disposed with the dielectric layer in a first direction, and first and second surfaces opposing each other in the first direction, third and fourth surfaces connected to the first and second surfaces and opposing each other in a second direction, fifth and sixth surfaces connected to the first to fourth surfaces and opposing each other in a third direction; an external electrode disposed on each of the third and fourth surfaces; and a side margin portion disposed on each of the fifth and sixth surfaces and including a plurality of dielectric crystal grains, and each of M cross-sections, where M is an integer greater than or equal to 2, of the side margin portion in the first direction and the third direction, has a different position in the second direction, each of the M cross-sections includes N regions, where N is an integer greater than or equal to 2, each of the N regions has a different position in the first direction, an average size of the plurality of dielectric crystal grains in each of the N regions in the M cross-sections has an average size, and a standard deviation of values of average sizes of the plurality of dielectric crystal grains is 5.3 or more and 8.3 or less.

A multilayer electronic component according to an example embodiment of the present disclosure may include: a body including a capacitance formation portion including a dielectric layer and internal electrodes alternately disposed with the dielectric layer in a first direction, and first and second surfaces opposing each other in the first direction, third and fourth surfaces connected to the first and second surfaces and opposing each other in a second direction, and fifth and sixth surfaces connected to the first to fourth surfaces and opposing each other in a third direction; external electrodes disposed on each of the third and fourth surfaces; and a side margin portion disposed on each of the fifth and sixth surfaces and including a plurality of dielectric crystal grains, and in the first and third directions, a first cross-section of the side margin portion, a second cross-section of the side margin portion, and a third cross-section of the side margin portion are at 1/10, ¼, and ½ points of a length of the side margin portion in the second direction, respectively, in the first cross-section, average sizes of the plurality of dielectric crystal grains in three first regions having different positions in the first direction are defined as GS1, GS2, and GS3, respectively, in the second cross-section, average sizes of the plurality of dielectric crystal grains measured in three second regions having different positions in the first direction are defined as GS4, GS5, and GS6, respectively, and in the third cross-section, average sizes of the plurality of dielectric crystal grains measured in three third regions having different positions in the first direction are defined as GS7, GS8, and GS9, respectively, a standard deviation of values of GS1 to GS9 may be 5.3 nm or more and 8.3 nm or less.

One effect of the present disclosure is to provide a highly reliable multilayer electronic component.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an example embodiment of the present disclosure;

FIG. 2 is a perspective view schematically illustrating a body and a side margin portion of FIG. 1;

FIG. 3 is a perspective view schematically illustrating the body of FIG. 1;

FIG. 4 is a cross-sectional view schematically illustrating cross-section I-I′ of FIG. 1;

FIG. 5A is a cross-sectional view schematically illustrating cross-section II-II′ of FIG. 2;

FIG. 5B is a cross-sectional view schematically illustrating cross-section III-III′ of FIG. 2;

FIG. 5C is a cross-sectional view schematically illustrating cross-section IV-IV′ of FIG. 2;

FIG. 6A is an image of a side margin portion of Comparative Example 1 captured with a scanning electron microscope (SEM);

FIG. 6B is an image of a side margin portion of Example captured with a scanning electron microscope (SEM);

FIG. 6C is an image of the side margin portion of Comparative Example 2 captured with a scanning electron microscope (SEM);

FIG. 7A is a graph illustrating results of the moisture resistance reliability evaluation of Comparative Example 1;

FIG. 7B is a graph illustrating results of the moisture resistance reliability evaluation of Example;

FIG. 8 is a graph illustrating results of an insulation breakdown voltage (BDV) evaluation of Example and Comparative Example 2; and

FIG. 9 is a graph illustrating an accelerated lifespan distribution of Example and Comparative Example 2.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. Furthermore, the example embodiments disclosed herein are provided for those skilled in the art to more completely explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

In the drawing, a first direction (x-direction) may be defined as a thickness (T) direction, a second direction (Y-direction) may be defined as a length (L) direction, and a third direction (Z-direction) may be defined as a width (W) direction.

### Multilayer Electronic Component

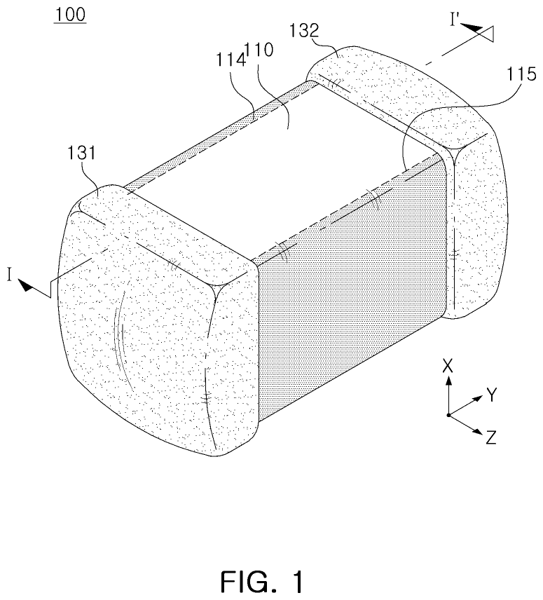

FIG. 1 is a perspective view schematically illustrating a multilayer electronic component according to an example embodiment of the present disclosure.

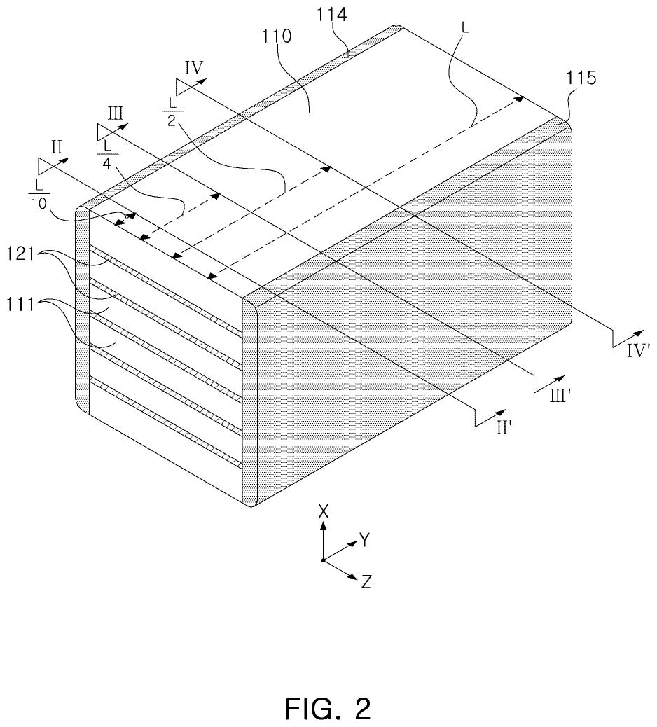

FIG. 2 is a perspective view schematically illustrating a body and a side margin portion of FIG. 1.

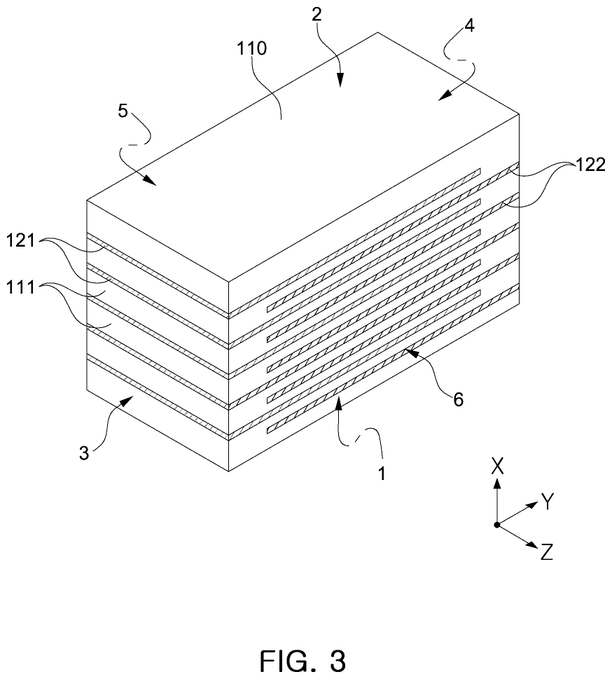

FIG. 3 is a perspective view schematically illustrating the body of FIG. 1.

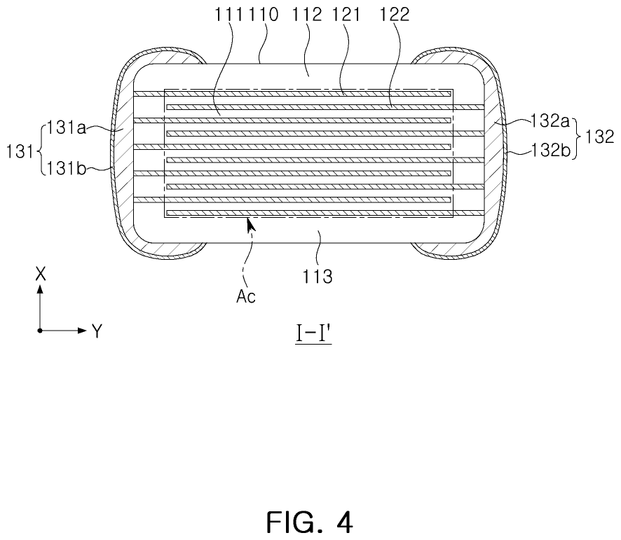

FIG. 4 is a cross-sectional view schematically illustrating cross-section I-I′ of FIG. 1.

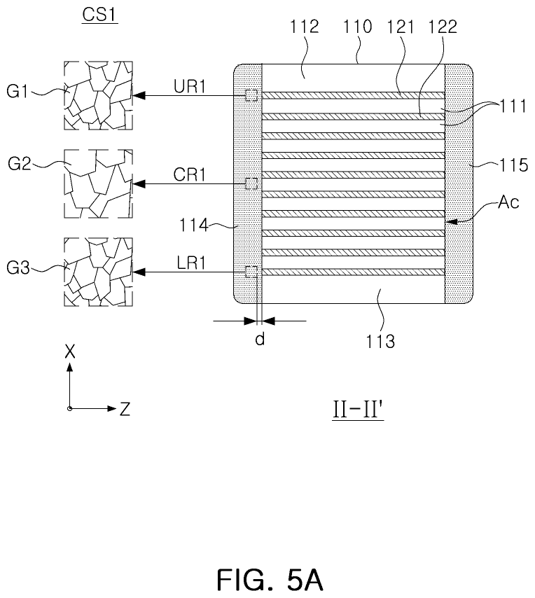

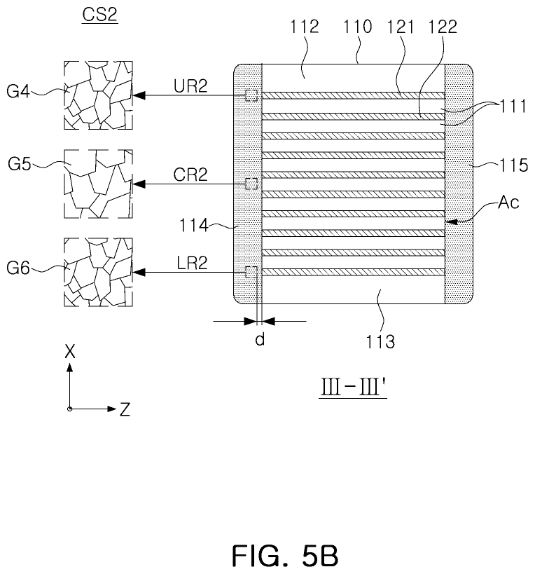

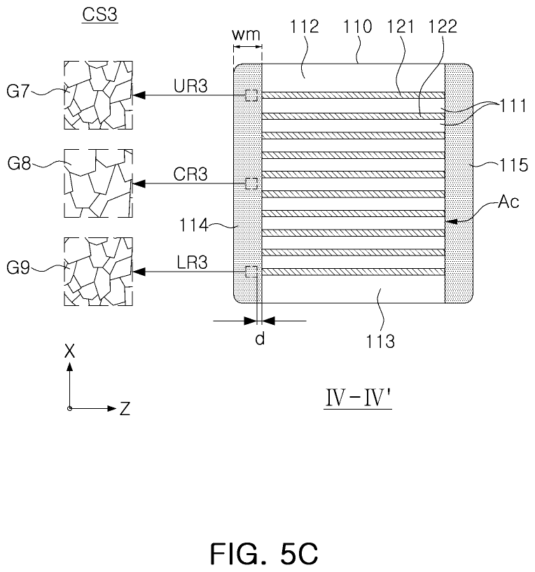

FIG. 5A is a cross-sectional view schematically illustrating cross-section II-II′ of FIG. 2.

FIG. 5B is a cross-sectional view schematically illustrating cross-section III-III′ of FIG. 2.

FIG. 5C is a cross-sectional view schematically illustrating cross-section IV-IV′ of FIG. 2.

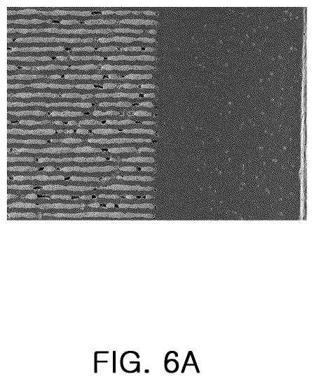

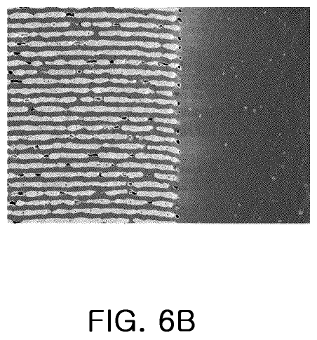

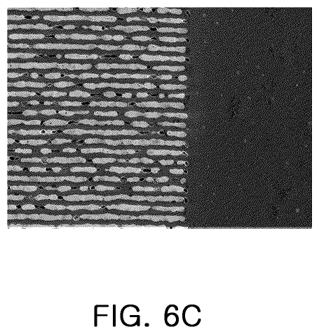

FIG. 6A is an image of a side margin portion of Comparative Example 1 captured with a scanning electron microscope (SEM).

FIG. 6B is an image of a side margin portion of Example captured with a scanning electron microscope (SEM).

FIG. 6C is an image of the side margin portion of Comparative Example 2 captured with a scanning electron microscope (SEM).

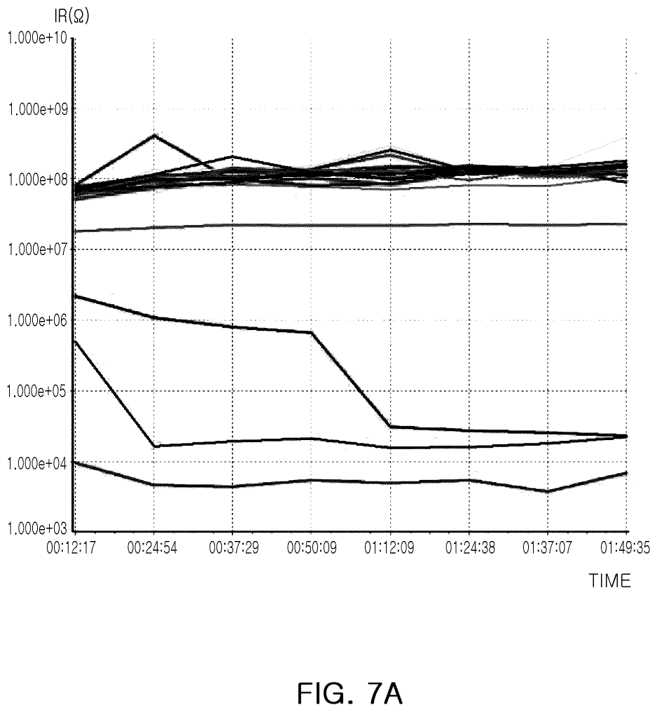

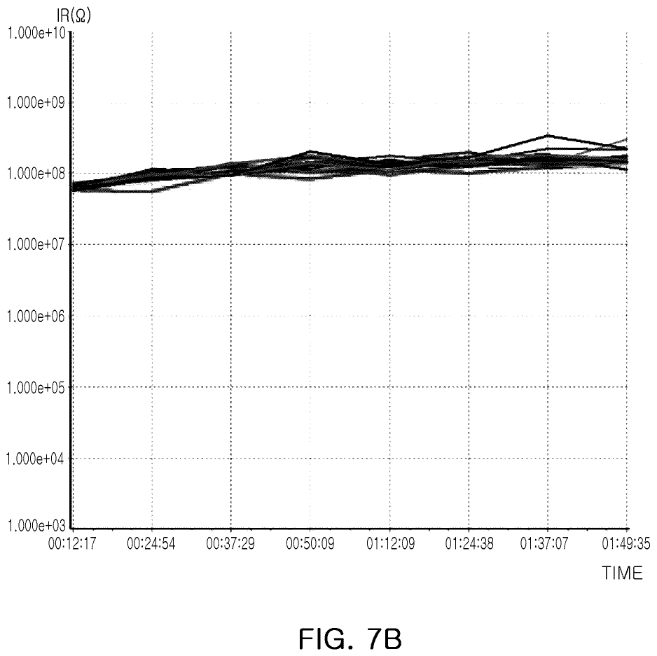

FIG. 7A is a graph illustrating results of the moisture resistance reliability evaluation of Comparative Example 1.

FIG. 7B is a graph illustrating results of the moisture resistance reliability evaluation of Example.

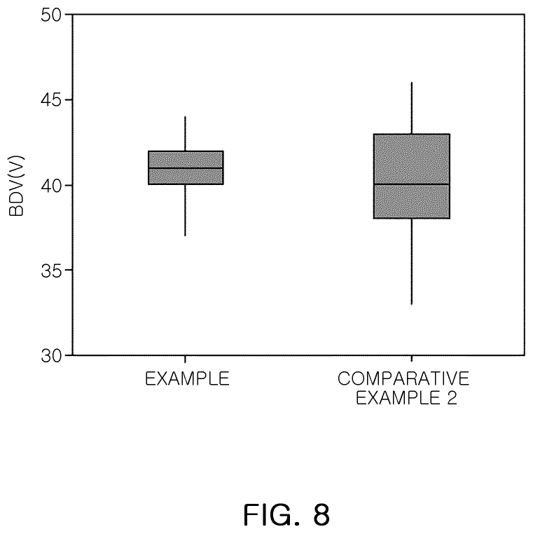

FIG. 8 is a graph illustrating results of an insulation breakdown voltage (BDV) evaluation of Example and Comparative Example 1.

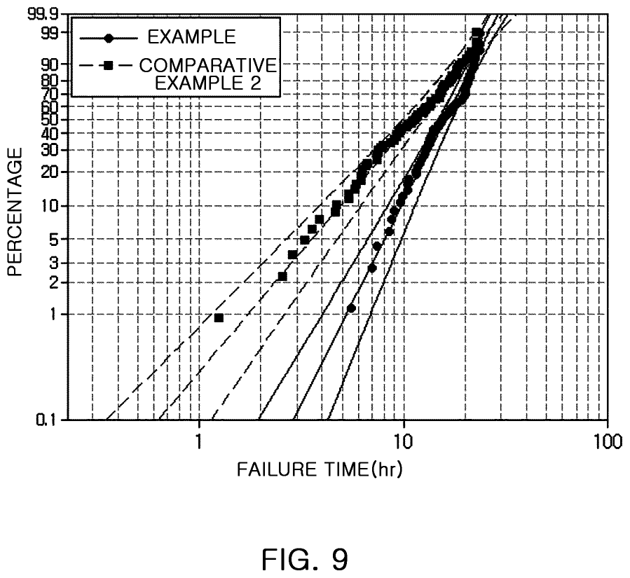

FIG. 9 is a graph illustrating an accelerated lifespan distribution of Example and Comparative Example 2.

Hereinafter, a multilayer electronic component 100 according to an example embodiment of the present disclosure will be described in detail with reference to FIGS. 1 to 9.

Additionally, a multilayer ceramic capacitor will be described as an example of a multilayer electronic component, but the present disclosure is not limited thereto and may be applied to various multilayer electronic components, such as an inductor, a piezoelectric element, a varistor, or a thermistor.

A multilayer electronic component 100 according to an example embodiment of the present disclosure may include a body 110, external electrodes 131 and 132, and side margin portions 114 and 115.

There is no particular limitation on a specific shape of the body 110, but as illustrated, the body 110 may be formed in a hexahedral shape or a similar shape. Due to the shrinkage of ceramic powder particles included in the body 110 during a sintering process or a polishing process on the corners of the body 110, the body 110 does not have a hexahedral shape with a perfect straight line, but may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, fifth and sixth surfaces 5 and 6 connected to the first to fourth surfaces 1, 2, 3 and 4 and opposing each other in a third direction.

The body 110 may include a capacitance formation portion Ac disposed inside the body 110 and having a capacitance formed therein, by including a dielectric layer 111 and internal electrodes 121 and 122 alternately disposed with the dielectric layer 111 in the first direction. A plurality of dielectric layers 111 forming a body 110 are in a sintered state, and boundaries between adjacent dielectric layers 111 may be integrated so as to be difficult to identify without using a scanning electron microscope (SEM).

The dielectric layer 111 may include, for example, a perovskite-type compound represented by ABO₃ as a main component. The perovskite compound represented by ABO₃ may include, for example, one or more of BaTiO₃, (Ba1-ₓCaₓ)TiO₃ (0<x<1), Ba(Ti1-_{y}Ca_{y})O₃ (0<y<1), (Ba1-ₓCaₓ)(Ti1-_{y}Zr_{y})O₃ (0<x<1, 0<y<1), Ba(Ti1-_{y}Zr_{y})O₃ (0<y<1), CaZrO₃, and (Ca1-ₓSrₓ)(Zr1-_{y}Ti_{y})O₃ (0<x<0.5, 0<y<0.5).

The internal electrodes 121 and 122 may include, for example, a first internal electrode 121 and a second internal electrode 122 that are alternately disposed in the first direction with the dielectric layer 111 interposed therebetween. The first internal electrode 121 and the second internal electrode 122 may be electrically separated from each other by a dielectric layer 111 disposed therebetween.

The first internal electrode 121 may extend to the third, fifth and sixth surfaces 3, 5 and 6 but may be spaced apart from the fourth surface 4. The first internal electrode 121 may be connected to the first external electrode 131. The second internal electrode 122 may extend to the fourth, fifth and sixth surfaces 4, 5 and 6 but may be spaced apart from the third surface 3. The second internal electrode 122 may be connected to the second external electrode 132.

A conductive metal included in the internal electrodes 121 and 122 may be one or more of Ni, Cu, Pd, Ag, Au, Pt, Sn, W, Ti and alloys thereof, and may more preferably include Ni, but the present invention is not limited thereto.

The body 110 may include cover portions 112 and 113 disposed on both surfaces of the capacitance formation portion Ac opposing the first direction.

The side margin portions 114 and 115 may be disposed on the fifth and sixth surfaces 5 and 6 of the body 110, respectively. The multilayer electronic component 100 may include a first side margin portion 114 disposed on the fifth surface 5 and a second side margin portion 115 disposed on the sixth surface 6.

The cover portions 112 and 113 and the side margin portions 114 and 115 may include, for example, a perovskite compound represented by ABO₃ as a main component. The perovskite compound represented by ABO₃ may include, for example, one or more of BaTiO₃, (Ba1-ₓCaₓ)TiO₃ (0<x<1), Ba(Ti1-_{y}Ca_{y})O₃ (0<y<1), (Ba1-ₓCaₓ) (Ti1-_{y}Zr_{y})O₃ (0<x<1, 0<y<1), Ba(Ti1-_{y}Zr_{y})O₃ (0<y<1), CaZrO₃, and (Ca1-ₓSrₓ)(Zr1-_{y}Ti_{y})O₃ (0<x≤0.5, 0<y≤0.5).

The external electrodes 131 and 132 may be disposed on the third and fourth surfaces 3 and 4 of the body 110, respectively. The multilayer electronic component 100 may include a first external electrode 131 disposed on the third surface 3 and a second external electrode 132 disposed on the fourth surface 4. The first external electrode 131 may be disposed on the third surface 3 and may extend onto a portion of the first, second, fifth, and sixth surfaces 1, 2, 5 and 6, and the second external electrode 132 may be disposed on the fourth surface 4 and may extend onto a portion of the first, second, fifth, and sixth surfaces 1, 2, 5 and 6.

The type or shape of the external electrodes 131 and 132 is not particularly limited, and may have a multilayer structure. For example, the external electrodes 131 and 132 may include base electrode layers 131a and 132a in contact with the internal electrodes 121 and 122 and plating layers 131b and 132b disposed on the base electrode layers 131a and 132a.

The base electrode layers 131a and 132a may be a sintered electrode layer including a metal and glass. The metal included in the base electrode layers 131a and 132a may include, for example, Cu, Ni, Pd, Pt, Au, Ag, Pb and/or alloys including the same. The glass included in the base electrode layers 131a and 132a may include, for example, one or more oxides of Ba, Ca, Zn, Al, B and Si.

The base electrode layers 131a and 132a may be comprised of only a sintered electrode layer, but the present disclosure is not limited thereto, and the base electrode layers 131a and 132a may include the sintered electrode layer including metal and glass, and the resin electrode layer disposed on the sintered electrode layer and including metal particles and resin.

The metal particles included in the resin electrode layer may include, for example, Cu, Ni, Pd, Pt, Au, Ag, Pb, Sn, and/or alloys including the same. The resin included in the resin electrode layer may include, for example, one or more of an epoxy resin, an acrylic resin and ethyl cellulose.

The plating layers 131b and 132b may include, for example, Ni, Sn, Pd, and/or alloys including the same, and may be formed of a plurality of layers. The plating layers 131b and 132b may be, for example, Ni plating layers or Sn plating layers, and may be formed in a form in which the Ni plating layer and the Sn plating layer are sequentially formed. The plating layers 131b and 132b may include a plurality of Ni plating layers and/or a plurality of Sn plating layers.

The drawing describes a structure in which the multilayer electronic component 100 has two external electrodes 131 and 132, but the present disclosure is not limited thereto, and the number or shape of the external electrodes 131 and 132 may be changed according to the shape of the internal electrodes 121 and 122 or other purposes.

The side margin portions 114 and 115 may include a plurality of dielectric crystal grains G1, G2, G3, G4, G5, G6, G7, G8 and G9. The side margin portions 114 and 115 may basically play a role in protecting the capacitance formation portion Ac. By suppressing a grain growth of a plurality of dielectric crystal grains G1 to G9 included in the side margin portions 114 and 115, the density of the side margin portions 114 and 115 may be improved, and thus, external moisture may be prevented from penetrating into the capacitance formation portion Ac, thereby improving the reliability of the multilayer electronic component 100.

In order to more effectively improve the reliability of the multilayer electronic component 100, it may be necessary to uniformly suppress the grain growth of the plurality of dielectric crystal grains G1 to G9. Through this, the density of the side margin portions 114 and 115 may be uniformly improved for each position.

Accordingly, in the multilayer electronic component 100 according to an example embodiment of the present disclosure, for each of M cross-sections of the side margin portions 114 and 115, in first and third directions, having different positions in the second direction, when an average size of a plurality of dielectric crystal grains G1 to G9 is measured in N regions having different positions in the first direction, a standard deviation of average size values measured M×N times may satisfy 5.3 or more and 8.3 or less. Each of the M and N may be an integer of 2 or more.

That is, the side margin portions 114 and 115 of the multilayer electronic component 100 according to an example embodiment of the present disclosure may satisfy a standard deviation of the average size values of crystal grains measured in a plurality of cross-sections×a plurality of regions of 5.3 or more and 8.3 or less. When the standard deviation satisfies the numerical range, the reliability of the multilayer electronic component 100 may be effectively improved.

When the standard deviation exceeds 8.3, the grain growth of the dielectric crystal grains included in the side margin portions 114 and 115 may not be uniformly suppressed, which may deteriorate BDV distribution and lifespan characteristics of the multilayer electronic component 100. When the standard deviation is less than 5.3, the grain growth of the dielectric crystals included in the side margin portions 114 and 115 may be excessively suppressed, and pores in the side margin portions 114 and 115 may increase, and as a result, the moisture resistance reliability of the multilayer electronic component 100 may be reduced.

The standard deviation may be calculated by the following mathematical expression 1. The standard deviation is measured by squaring the deviations and summing the squares of the deviations, and then dividing the summed results by the number of measurements, and calculating a square root thereof, and may denote a square root of an average of the squares of the deviations.

$$σ = \sqrt{\frac{1}{M \times N} {{\sum }_{i = 1}}^{M \times N} {( {x}_{i} - \overline{x} )}^{2}} \qquad [ Mathematical Expression 1 ]$$

The M cross-sections are not particularly limited, but as illustrated in FIG. 2 and FIG. 5A to 5C, the M cross-sections may include a first cross-section CS1 cut at a 1/10 point of a length (L) of the side margin portions 114 and 115 in the second direction, a second cross-section CS2 cut at a ¼ point of the length (L) of the side margin portions 114 and 115 in the second direction, and a third cross-section CS3 cut at a ½ point of the length (L) of the side margin portions 114 and 115 in the second direction.

The fact that the M cross-sections may include the first to third cross-sections CS1, CS2 and CS3 which are first and third direction cross-sections in the first and third directions, cut at 1/10, ¼, and ½ points of the length (L) of the side margin portions 114 and 115 in the second direction, may mean that the average size of the dielectric crystal grains G1 to G9 and the standard deviation of the average size values are measured in various second direction positions. That is, when the M cross-sections include the first to third cross-sections CS1, CS2 and CS3 and the standard deviation satisfies 5.3 or more and 8.3 or less, the side margin portions 114 and 115 may include the dielectric crystal grains G1 to G9 having a certain level of size uniformity regardless of the second direction position, and thus, the reliability of the multilayer electronic component 100 may be more effectively improved.

In the present disclosure, the 1/10, ¼, and ½ points of the length (L) in the second direction of the side margin portions 114 and 115 may mean points in the vicinity that may be considered as 1/10, ¼, and ½ points of the length (L) of the side margin portions 114 and 115 in the second direction by a person skilled in the art. Accordingly, in consideration of error of a polishing process for measurement, or the like, the 1/10 point may mean a point between 1/10± 1/50 of the length (L) of the side margin portions 114 and 115 in the second direction, the ¼ point may mean a point between ¼± 1/50 of the length (L) of the side margin portions 114 and 115 in the second direction, and the ½ point may mean a point between ½± 1/50 of the length (L) of the side margin portions 114 and 115 in the second direction. The 1/10, ¼, and ½ points of the length (L) in the second direction may be determined by a scanning electron microscope (SEM). Other methods and/or tools appreciated by one of ordinary skill in the art, even if not described in the present disclosure, may also be used.

The N regions are not particularly limited, but may include three regions whose positions in the first direction are different from each other.

For example, when the average sizes of a plurality of dielectric grains G1 to G3 measured in three first regions UR1, CR1 and LR1 having different positions in the first direction, in the first cross-section CS1, are defined as GS1, GS2 and GS3, the average sizes of a plurality of dielectric grains G4 to G6 measured in three second regions UR2, CR2 and LR2 having different positions in the first direction, in the second cross-section CS2, are defined as GS4, GS5 and GS6, and the average sizes of a plurality of dielectric grains G7 to G9 measured in three third regions UR3, CR3 and LR3 having different positions in the first direction, among the third cross-section CS3, are defined as GS7, GS8 and GS9, the standard deviation of the values of GS1 to GS9 may be 5.3 nm or more and 8.3 nm or less. That is, the standard deviation of the GS1 to GS9 values may mean, for example, a standard deviation between nine average size values measured at a total of nine points.

For example, the N regions may include upper regions (e.g., first regions) UR1, UR2 and UR3, central regions CR1, CR2 and CR3, and lower regions (e.g., second regions) LR1, LR2 and LR3 of the side margin portions 114 and 115. Here, the central regions CR1, CR2 and CR3 may correspond to a central region of the capacitance formation portion Ac in the first direction, the upper regions UR1, UR2 and UR3 may correspond to an uppermost region (e.g., a first region) of the capacitance formation portion Ac in the first direction, and the lower regions LR1, LR2 and LR3 may correspond to a lowermost region(e.g., a second region) of the capacitance formation portion Ac in the first direction.

That is, the first region UR1, CR1 and LR1 may include a first central region CR1 corresponding to the central region of the capacitance formation portion Ac in the first direction, a first upper region (e.g., a first-first region) UR1 corresponding to the uppermost region of the capacitance formation portion Ac in the first direction, and a first lower region (e.g., a first-second region) LR1 corresponding to the uppermost region of the capacitance formation portion Ac in the first direction.

The second region UR2, CR2 and LR2 may include a second central region CR2 corresponding to the central region of the capacitance formation portion Ac in the first direction, a second upper region (e.g., a second-first region) UR2 corresponding to the uppermost region of the capacitance formation portion Ac in the first direction, and a second lower region (e.g., a second-second region) LR2 corresponding to the lowermost region of the capacitance formation portion Ac in the first direction.

The third regions UR3, CR3 and LR3 may include a third central region CR3 corresponding to the central region of the capacitance formation portion Ac in the first direction, a third upper region (e.g., a third-first region) UR3 corresponding to the uppermost region of the capacitance formation portion Ac in the first direction, and a third lower region (e.g., a third-second region) LR3 corresponding to the lowermost region of the capacitance formation portion Ac in the first direction.

The fact that the N regions may include the upper regions UR1, UR2 and UR3, the central regions CR1, CR2 and CR3, and the lower regions LR1, LR2 and LR3 may mean that the average sizes of the dielectric crystal grains G1 to G9 and the standard deviation of the average size values are measured at various first direction positions. That is, when the N regions include the upper regions UR1, UR2 and UR3, the central regions CR1, CR2 and CR3 and the lower regions LR1, LR2 and LR3, and when the standard deviation satisfies 5.3 or more and 8.3 or less, the side margin portions 114 and 115 may include dielectric grains G1 to G9 having a certain level of size uniformity regardless of the first direction position, and thus, the reliability of the multilayer electronic component 100 may be improved more effectively.

Meanwhile, in order to more accurately measure the average sizes of the dielectric grains G1 to G9, the N regions may each include 500 or more multiple dielectric grains G1 to G9. An upper limit of the number of dielectric grains G1 to G9 included in each of the N regions is not particularly limited, but may be, for example, 1,000 or less.

Hereinafter, an example of a method of measuring the standard deviation will be described. First, the external electrodes 131 and 132 of the multilayer electronic component 100 are removed, and then the first and third direction cross-sections (first cross-sections) are exposed, which are polished to a 1/10 point of the length (L) of the side margin portions 114 and 115 in the second direction. The first central region CR1, the first upper region UR1, and the first lower region LR1 are defined in the first cross-section CS1.

In order to prevent interference by the internal electrodes, the first regions UR1, CR1 and LR1 may be defined in a position spaced apart from the capacitance formation portion Ac by a certain distance dl. The dl may be, for example, 100 nm or more and 500 nm or less. The first central region CR1 may be set to overlap the first direction central portion of the capacitance formation portion Ac in the third direction, the first upper region UR1 may be set to overlap, in the third direction, the internal electrodes 121 and 122 disposed in an uppermost portion based on the first direction, and the first lower region LR1 may be set to overlap, in the third direction, the internal electrodes 121 and 122 disposed in a lowermost portion based on the first direction. Next, images by capturing the first central region CR1, the first upper region UR1, and the first lower region LR1 with a scanning electron microscope (SEM) at 50,000× magnification are obtained, respectively. Each image is configured to have 500 or more dielectric crystal grains G1 to G3. The GS1 to GS3, and the number of dielectric crystal grains G1 to G3 may be derived by analyzing each image with an image analysis program. Other methods and/or tools appreciated by one of ordinary skill in the art, even if not described in the present disclosure, may also be used.

Next, a chip polished to the 1/10 point of the length (L) of the side margin portions 114 and 115 in the second direction is polished again to the ¼ point of the length (L) of the side margin portions 114 and 115 in the second direction, thereby exposing cross-sections in the first and third directions (second cross-sections). The second central region CR2, the second upper region UR2, and the second lower region LR2 are defined in the second cross-section CS2. The same process as the method of measuring the average grain size in the first cross-section CS1 may be performed in the second cross-section CS2, so that GS4 to GS6 may be calculated.

Next, a chip polished to the ¼ point of the length (L) of the side margin portions 114 and 115 in the second direction is again polished to the ½ point of the length (L) of the side margin portions 114 and 115 in the second direction, thereby exposing cross-sections in the first and third directions (third cross-sections). In the third cross-section CS3, the third central region CR3, the third upper region UR3 and the third lower region LR3 are defined. The same process as the method of measuring the average grain size in the first cross-section CS1 may be performed in the third cross-section CS3, so that GS7 to GS9 may be calculated.

Accordingly, the standard deviation of the average size values of GS1 to GS9 may be calculated. However, the present disclosure is not limited thereto, and the M×N may have various values, such as 3×4, 4×3, 4×4, 5×5, and the like.

In an example embodiment, the average sizes GS2, GS5 and GS8 of the plurality of dielectric crystal grains measured in the central regions CR1, CR2 and CR3 may be greater than the average sizes GS1, GS3, GS4, GS6, GS7 and GS9 of the plurality of dielectric crystal grains measured in the upper regions UR1, UR2 and UR3 or the lower regions LR1, LR2 and LR3. That is, the GS1 to GS9 may satisfy one or more of GS2>GS1, GS2>GS3, GS5>GS4, GS5>GS6, GS8>GS7, and GS8>GS9.

The dielectric crystal grains G1, G4 and G7 included in the upper regions UR1, UR2 and UR3 and the dielectric crystal grains G3, G6 and G9 included in the lower regions LR1, LR2 and LR3 may have grain growth suppressed more than the dielectric crystal grains G2, G5 and G8 included in the central regions CR1, CR2 and CR3 due to the influence of a sintering agent diffused from the cover portions 112 and 113. Accordingly, one or more of GS2>GS1, GS2>GS3, GS5>GS4, GS5>GS6, GS8>GS7, and GS8>GS9 may be satisfied.

However, the side margin portions 114 and 115 of the multilayer electronic component 100 according to an example embodiment of the present disclosure may include dielectric crystal grains G1 to G9 having a certain level of size uniformity regardless of the first direction position. Accordingly, a ratio of the average sizes GS2, GS5 and GS8 of the plurality of dielectric crystal grains measured in the upper regions UR1, UR2 and UR3 or the lower regions LR1, LR2 and LR3 to the average sizes GS1, GS3, GS4, GS6, GS7 and GS9 of the plurality of dielectric crystal grains measured in the central regions CR1, CR2 and CR3 may be 0.923 or more and 0.987 or less. That is, one or more of 0.923≤GS1/GS2≤0.987, 0.923≤GS3/GS2≤0.987, 0.923≤GS4/GS5≤0.987, 0.923≤GS6/GS5≤0.987, 0.923≤GS7/GS8≤0.987, and 0.923≤GS9/GS8≤0.987 may be satisfied. When the numerical ranges are satisfied, the reliability of the multilayer electronic component 100 may be improved more effectively.

The average sizes GS2, GS5 and GS8 of the plurality of dielectric crystal grains measured in the central regions CR1, CR2 and CR3 may be, for example, 200 nm or more and 300 nm or less.

Meanwhile, the dielectric layer 111 and the side margin portions 114 and 115 may include the following subcomponents in addition to the ABO₃ main component in order to implement the multilayer electronic component 100 with desired characteristics.

The subcomponents are described based on the mole number of elements, and may be calculated by converting to the added content of the oxides or carbonates of additives before sintering. The content of elements before and after sintering may not have a large error value unless there are special circumstances, and the types and contents of elements included in the dielectric layer 111 and the side margin portions 114 and 115 may be measured using various measuring methods such as SEM-EDS, TEM-EDS, and STEM-EDS after sintering.

As an example of a more specific method of measuring the content of each element included in the side margin portions 114 and 115, a thinned analysis sample is prepared using a focused ion beam (FIB) device for a region corresponding to the side margin portions 114 and 115 among the cross-sections of the multilayer electronic component 100. Then, a damage layer on a surface of the thinned sample is removed using Ar ion milling, and then, each component is mapped from the image obtained using (S)TEM-EDS to conduct a qualitative/quantitative analysis. In this case, the qualitative/quantitative analysis graph of each component may be converted into a mass fraction (wt %), an atomic percentage (at %), or a mole fraction (mol %) of each element and then expressed.

### 1) First Subcomponent

The dielectric layer 111 and the side margin portions 114 and 115 may include a first subcomponent including one or more of Dy, Y, Tb, Sc, La, Nd, Eu, Gd, Ho, Er, Yb, and Lu. The first subcomponent may serve to improve the reliability of the multilayer electronic component 100. A total content of the first subcomponent included in the side margin portions 114 and 115 may be, for example, 0.6 mol or more and 3.0 mol or less relative to 100 mol of Ti.

### 2) Second Subcomponent

The dielectric layer 111 and the side margin portions 114 and 115 may include a second subcomponent including one or more of Mg and Zr. The second subcomponent may be included in the side margin portions 114 and 115 thereby serving to lower a sintering temperature of the side margin portions 114 and 115 and to suppress grain growth. A total content of the second subcomponent included in the side margin portions 114 and 115 may be, for example, 0.1 mol or more and 3.0 mol or less relative to 100 mol of Ti.

### 3) Third Subcomponent

The dielectric layer 111 and the side margin portions 114 and 115 may include a third subcomponent including one or more of Mn, V, Cr, Fe, Ni, Co, and Zn. The third subcomponent is an atomic variable acceptor element, and may serve to improve the dielectric properties and high-temperature accelerated life characteristics of the multilayer electronic component 100. A total content of the third subcomponent included in the side margin portions 114 and 115 may be, for example, 0.01 mol or more and 8.0 mol or less relative to 100 mol of Ti.

### 4) Fourth Subcomponent

The dielectric layer 111 and the side margin portions 114 and 115 may include a fourth subcomponent including one or more of Si and Al. The Si may suppress grain growth of the dielectric crystal grains included in the side margin portions 114 and 115, thereby serving to improve the density of the side margin portions 114 and 115. The Al may contribute to low-temperature densification through liquefaction during sintering and may improve the high-temperature withstand voltage characteristics of the multilayer electronic component 100.

In order to appropriately control the microstructure of the side margin portions 114 and 115, the side margin portions 114 and 115 may include, for example, one or more of Dy, Mn, Mg, V, Si and Al, and may also include all of Dy, Mn, Mg, V, Si and Al.

A size of the multilayer electronic component 100 is not particularly limited, but a maximum length of the multilayer electronic component 100 in the second direction may be 0.1 mm to 6.0 mm, a maximum width of the multilayer electronic component 100 in the third direction may be 0.1 mm to 5.0 mm, and a maximum thickness of the multilayer electronic component 100 in the first direction may be 0.05 mm to 3.5 mm.

An average thickness of the dielectric layer 111 is not particularly limited, but an average thickness of the dielectric layer 111 may be, for example, 0.1 μm to 20 μm, 0.1 μm to 10 μm, 0.1 μm to 5 μm, 0.1 μm to 2 μm, or 0.1 μm to 0.4 μm.

An average thickness of the internal electrodes 121 and 122 is not particularly limited, but the average thickness of the internal electrodes 121 and 122 may be, for example, 0.1 μm to 3.0 μm, 0.1 μm to 1.0 μm, or 0.1 μm to 0.4 μm.

The average thickness of the dielectric layer 111 and the average thickness of the internal electrodes 121 and 122 refer to the average thickness of the dielectric layer 111 and the internal electrodes 121 and 122 in the first direction, respectively. The average thickness of the dielectric layer 111 and the average thickness of the internal electrodes 121 and 122 may be measured by scanning the first and third direction cross-sections of the multilayer electronic component 100 with a scanning electron microscope (SEM) at 10,000× magnification. More specifically, the average thickness of the dielectric layer 111 may be measured by measuring thicknesses at multiple points of one dielectric layer 111, for example, at five points spaced apart from each other by equal intervals in the third direction, and then taking an average value thereof.

Additionally, the average thickness of the internal electrodes 121 and 122 may be measured by measuring the thicknesses at multiple points of one internal electrodes 121 and 122, for example, at five points spaced apart from each other by equal intervals in the third direction, and then taking an average value thereof. The 5 points spaced apart from each other by equal intervals may be designated in the capacitance formation portion Ac. Meanwhile, when the average value measurement is performed for each of 10 dielectric layers 111 and 10 internal electrodes 121 and 122 and then the average value thereof is measured, the average thickness of the dielectric layer 111 and the average thickness of the internal electrodes 121 and 122 may be further generalized.

An average thickness of the cover portions 112 and 113 is not particularly limited. The average thickness of the cover portions 112 and 113 may be, for example, 150 μm or less, 100 μm or less, 30 μm or less, or 20 μm or less. The average thickness of the cover portions 112 and 113 may be, for example, 5 μm or more, 10 μm or more, or 30 μm or more. Here, an average thickness tc of the cover portions 112 and 113 refers to an average thickness of each of the first cover portion 112 and the second cover portion 113.

The average thickness tc of the cover portions 112 and 113 may refer to an average thickness of the cover portions 112 and 113 in the first direction, and may be an average value of the thicknesses in the first direction measured at five points spaced apart from each other by equal intervals in the first and third direction cross-sections of the multilayer electronic component 100.

An average thickness wm of the side margin portions 114 and 115 is not particularly limited. The average thickness wm of the side margin portions 114 and 115 may be, for example, 3 μm or more and 100 μm or less. For example, when the multilayer electronic component 100 has a size of 1005 size (length: about 1.0 mm, width: about 0.5 mm, thickness: about 0.5 mm) or less, the average thickness wm of the side margin portions 114 and 115 may be 3 μm or more and 25 μm or less, for example, 14 μm or more and 20 μm or less. The average thickness wm of the side margin portions 114 and 115 refers to an average thickness of each of the first side margin portion 114 and the second side margin portion 115.

An average thickness tm of the side margin portions 114 and 115 may refer to an average thickness of the side margin portions 114 and 115 in the third direction, and may be an average value of the thicknesses in the third direction measured at five points spaced apart from each other at equal intervals in the first and third direction cross-sections of the multilayer electronic component 100. The average thickness tm of the side margin portions 114 and 115 may be measured, for example, in the third cross-section CS3.

Hereinafter, an example of a method of forming a multilayer electronic component 100 will be described. However, the manufacturing method of the multilayer electronic component 100 is not limited thereto.

First, ceramic powder particles for forming a dielectric layer 111 is prepared. The ceramic powder particles may include, for example, BaTiO₃, (Ba1-ₓCaₓ) TiO₃ (0<x≤1), Ba(Ti1-_{y}Ca_{y})O₃ (0<y≤1), (Ba1-ₓCaₓ) (Ti1-_{y}Zr_{y})O₃ (0<x≤1, 0<y≤1), or Ba(Ti1-_{y}Zr_{y})O₃ (0<y≤1). BaTiO₃ powder particles may be synthesized, for example, by reacting a titanium raw material such as titanium dioxide with a barium raw material such as barium carbonate. Methods of synthesizing the ceramic powder include, for example, a solid-state method, a sol-gel method, and a hydrothermal synthesis method, but the present invention is not limited thereto. Next, after drying and grinding the prepared ceramic powder particles, an organic solvent such as ethanol, a binder such as polyvinyl butyral and other auxiliary ingredients are mixed to prepare a ceramic slurry, and then the ceramic slurry is applied to a carrier film and dried to prepare a dielectric layer forming sheet.

Next, a conductive paste for internal electrodes, including metal powder particles, a binder and an organic solvent is printed on a sheet for forming dielectric layers with a predetermined thickness using a screen-printing method or a gravure printing method, thus forming an internal electrode pattern.

Then, the sheet for forming the dielectric layer on which the internal electrode pattern is printed is peeled off from the carrier film, and then a ceramic laminate is formed by stacking and pressing a predetermined number of layers. In order to form cover portions 112 and 113 after sintering, a predetermined number of sheets for forming cover portion on which the internal electrode pattern is not formed may be stacked on upper and lower portions of the ceramic laminate. Accordingly, the ceramic laminate is cut to have a predetermined chip size. In this case, ends of the internal electrode patterns are exposed on both surfaces of the cut chip in the third direction.

Next, the sheet for forming the margin portion is attached to both surfaces of the cut chip in the third direction and then sintered to form the body 110 and the side margin portions 114 and 115. The sintering may be performed, for example, at a temperature of 1000° C. or higher and 1400° C. or lower in a 1.0% H2/99.0% N2 to 3.5% H2/96.5% N2 (H₂O/H₂/N₂ atmosphere) for 1 to 3 hours.

Meanwhile, the sheet for forming the margin portion may be formed in a similar manner to the dielectric layer forming sheet, but the types and contents of the subcomponents included in the sheet for forming the margin portion may be different from those included in the dielectric layer forming sheet.

The sheet for forming the margin portion may include a predetermined amount of first to fourth subcomponent powder particles. The sheet for forming the margin portion may include, for example, one or more of Dy, Mn, Mg, V, Si, and Al. The subcomponent powder particles may be added to the sheet for forming the margin portion in the form of oxides and/or carbonates, but the present disclosure is not limited thereto.

Next, external electrodes 131 and 132 are formed. For example, when the base electrode layers 131a and 132a include a sintered electrode layer, the body 110 may be dipped in a conductive paste for external electrodes, including a metal powder, glass frit, a binder and an organic solvent, and then the conductive paste for external electrodes may be sintered at a temperature of 500° C. to 900° C. to form a sintered electrode layer.

For example, when the base electrode layers 131a and 132a includes a resin electrode layer, the body may be dipped in a conductive resin composition including metal powder particles, a resin, binder and an organic solvent, and then cured at a temperature of 250° C. to 550° C. to form a resin electrode layer.

Additionally, an electrolytic plating method and/or an electroless plating method may be additionally performed to form a plating layers 131b and 132b on the base electrode layers 131a and 132a.

### Example

A sample chip having a size of 1005 (length: about 1.0 mm, width: about 0.5 mm, thickness: about 0.5 mm) was prepared by the above-described manufacturing method. Then, polishing to the 1/10 point of the length of the side margin portion in the second direction was performed to expose the cross-sections in the first and third directions (first cross-sections). In the first cross-section, the upper region, central region and lower region of the side margin were analyzed by a scanning electron microscope (SEM) at 50,000× magnification, and the average sizes GS1, GS2 and GS3 of the dielectric crystal grains included in each region was calculated. The number of crystal grains included in each region was approximately 700 to 800.

Next, polishing to the ¼ point of the length of the side margin region in the second direction was performed to expose the second cross-section, and the average sizes GS4, GS5 and GS6 of the dielectric crystal grains included in the upper region, the central region and the lower region of the side margin region was calculated in the same method.

Then, polishing to the ½ point of the length of the side margin region in the second direction was performed to expose the third cross-section, and the average sizes GS7, GS8 and GS9 of the dielectric crystal grains included in the upper region, the central region and the lower region of the side margin region was calculated in the same method. Finally, the standard deviation for nine measurement values (GS1 to GS9) was measured.

Comparative Example 1 had the standard deviation less than 5.3, Example satisfied the standard deviation of 5.3 or more and 8.3 or less, and Comparative Example 2 had the standard deviation greater than 8.3.

Referring to FIGS. 6A to 6C, it may be confirmed that the number of pores in Comparative Example 1 is greater than in the Example. In FIGS. 6A to 6C, the pores are brightly marked regions. Additionally, referring to FIG. 6C, it may be confirmed that numerous empty spaces appearing in black have occurred. This is expected because the side margin portion was not densified in Comparative Example 2 as compared to Example.

A moisture-resistant reliability evaluation was conducted on the sample chips of Comparative Example 1 and Example. The moisture-resistant reliability evaluation was conducted for approximately 2 hours in an environment of 85° C., 85% humidity, and 1 Vr for 20 sample chips each of Comparative Example 1 and Example. Referring to FIGS. 7A and 7B, in the case of Example, there were no sample chips having reduced insulation resistance IR, but in the case of Comparative Example 1, there were sample chips having drastically reduced insulation resistance IR. This is because, when the standard deviation is less than 5.3, the grain growth of the dielectric crystal grains included in the side margin is excessively suppressed, resulting in the generation of a large number of pores, which is expected to result in a decrease in the moisture resistance reliability of the sample chip.

Next, the insulation breakdown voltage (BDV) evaluation and accelerated lifespan evaluation were conducted for Example and Comparative Example 2. When a DC voltage was applied to 40 samples of Example and Comparative Example 2 under the conditions of current: 0.01 A and measurement time: 50 ms, the insulation breakdown voltage (BDV) was calculated as a voltage value at the time when the leakage current occurred. The accelerated lifespan evaluation measured the lifespans of 40 samples of Example and Comparative Example 2 under the conditions of temperature 125° C. and 1.5×Vr.

Referring to FIGS. 8 and 9, it may be confirmed that Comparative Example 2 has inferior BDV distribution and lifespan characteristics as compared to Example. In the case of Comparative Example 2, it is expected that the grain growth of the dielectric crystal grains included in the side margin portion is not uniformly suppressed, so that the standard deviation exceeds 8.3. Accordingly, it is expected that the BDV distribution and lifespan characteristics deteriorate as the density of the side margin portion decreases.

That is, when the standard deviation satisfies 5.3 or more and 8.3 or less, it may be confirmed that the reliability of the multilayer electronic component is improved.

Although an example embodiment of the present disclosure has been described in detail above, the present disclosure is not limited to the above-described embodiments and the accompanying drawings but is defined by the appended claims. Therefore, those of ordinary skill in the art may make various replacements, modifications, or changes without departing from the technical concept of the present disclosure defined by the appended claims, and these replacements, modifications, or changes should be construed as being included in the technical concept of the present disclosure.

Additionally, the expression ‘an example embodiment’ used in the present disclosure does not mean the same embodiment, and is provided to emphasize and explain different unique characteristics. However, the example embodiments presented above do not preclude being implemented in combination with the features of another embodiment. For example, although items described in a specific example embodiment are not described in another example embodiment, the items may be understood as a description related to another example embodiment unless a description opposite or contradictory to the items is in another example embodiment.

In the present disclosure, a meaning of being connected is a concept including not only directly connected but also indirectly connected through an adhesive layer or the like. Furthermore, a meaning of electrically connected is a concept including both physically connected and not connected. In addition, expressions such as first and second are used to distinguish one component from another, and do not limit the order and/or importance of the components. In some cases, a first component may be referred to as a second component without departing from the scope of rights, or similarly, the second component may be referred to as the first component.

What is claimed is:

1. A multilayer electronic component, comprising:
a body including a capacitance formation portion including a dielectric layer and internal electrodes alternately disposed with the dielectric layer in a first direction, and first and second surfaces opposing each other in the first direction, third and fourth surfaces connected to the first and second surfaces and opposing each other in a second direction, fifth and sixth surfaces connected to the first to fourth surfaces and opposing each other in a third direction;
an external electrode disposed on each of the third and fourth surfaces; and
a side margin portion disposed on each of the fifth and sixth surfaces and including a plurality of dielectric crystal grains,
wherein each of M cross-sections, where M is an integer greater than or equal to 2, of the side margin portion in the first direction and the third direction, has a different position in the second direction,
each of the M cross-sections includes N regions, where N is an integer greater than or equal to 2,
each of the N regions has a different position in the first direction,
an average size of the plurality of dielectric crystal grains in each of the N regions in the M cross-sections has an average size, and
a standard deviation of values of average sizes of the plurality of dielectric crystal grains is 5.3 or more and 8.3 or less.

2. The multilayer electronic component according to claim 1, wherein the M cross-sections include a first cross-section cut at a 1/10 point of a length of the side margin portion in the second direction, a second cross-section cut at a ¼ point of the length of the side margin portion in the second direction, and a third cross-section cut at a ½ point of the length of the side margin portion in the second direction.

3. The multilayer electronic component according to claim 2, wherein the N regions include a first region of the side margin portion, a central region of the side margin portion, and a second region of the side margin portion, and the central region of the side margin portion is disposed between the first region of the side margin portion and the second region of the side margin portion.

4. The multilayer electronic component according to claim 3, wherein the average size of the plurality of dielectric crystal grains measured in the central region is greater than the average size of the plurality of dielectric crystal grains measured in the first region or the second region.

5. The multilayer electronic component according to claim 3, wherein a ratio of the average size of the plurality of dielectric crystal grains measured in the first region or the second region to the average size of the plurality of dielectric crystal grains measured in the central region is 0.923 or more and 0.987 or less.

6. The multilayer electronic component according to claim 3, wherein the average size of the plurality of dielectric crystal grains measured in the central region is 200 nm or more and 300 nm or less.

7. The multilayer electronic component according to claim 3, wherein the central region corresponds to a central region of the capacitance formation portion in the first direction,
the first region corresponds to a first region of the capacitance formation portion in the first direction,
the second region corresponds to a second region of the capacitance formation portion in the first direction, and
the central region of the capacitance formation portion is disposed between the first region of the capacitance formation portion and the second region of the capacitance formation portion.

8. The multilayer electronic component according to claim 1, wherein each of the N regions includes 500 or more dielectric crystal grains among the plurality of dielectric crystal grains.

9. The multilayer electronic component according to claim 1, wherein the side margin portion includes one or more selected from the group consisting of Dy, Y, Tb, Sc, La, Nd, Eu, Gd, Ho, Er, Yb, and Lu.

10. The multilayer electronic component according to claim 1, wherein the side margin portion includes one or more selected from the group consisting of Mg and Zr.

11. The multilayer electronic component according to claim 1, wherein the side margin portion includes one or more selected from the group consisting of Mn, V, Cr, Fe, Ni, Co and Zn.

12. The multilayer electronic component according to claim 1, wherein the side margin portion includes one or more selected from the group consisting of Si and Al.

13. A multilayer electronic component, comprising:
a body including a capacitance formation portion including a dielectric layer and internal electrodes alternately disposed with the dielectric layer in a first direction, and first and second surfaces opposing each other in the first direction, third and fourth surfaces connected to the first and second surfaces and opposing each other in a second direction, and fifth and sixth surfaces connected to the first to fourth surfaces and opposing each other in a third direction;
an external electrode disposed on each of the third and fourth surfaces; and
a side margin portion disposed on each of the fifth and sixth surfaces and including a plurality of dielectric crystal grains,
wherein, in the first and third direction, a first cross-section of the side margin portion, a second cross-section of the side margin portion, and a third cross-section of the side margin portion are at 1/10, ¼, and ½ points of a length of the side margin portion in the second direction, respectively,
in the first cross-section, average sizes of the plurality of dielectric crystal grains in three first regions having different positions in the first direction are defined as GS1, GS2, and GS3, respectively,
in the second cross-section, average sizes of the plurality of dielectric crystal grains measured in three second regions having different positions in the first direction are defined as GS4, GS5 and GS6, respectively, and
in the third cross-section, average sizes of the plurality of dielectric crystal grains measured in three third regions having different positions in the first direction are defined as GS7, GS8 and GS9, respectively,
a standard deviation of values of GS1 to GS9 is 5.3 nm or more and 8.3 nm or less.

14. The multilayer electronic component according to claim 13, wherein the capacitance portion includes a first region, a second region, and a central region that is between the first region and the second region,
the first regions include a first central region corresponding to a central region of the capacitance formation portion in the first direction, a first-first region corresponding to the first region of the capacitance formation portion in the first direction, and a first-second region corresponding to the second region of the capacitance formation portion in the first direction, where the first central region is disposed between the first-first region and the second-first region,
the second regions include a second central region corresponding to the central region of the capacitance formation portion in the first direction, a second-first region corresponding to the first region of the capacitance formation portion in the first direction, and a second-second region corresponding to the second region of the capacitance formation portion in the first direction, where the second central region is disposed between the second-first region and the second-second region, and
the third regions include a third central region corresponding to the central region of the capacitance formation portion in the first direction, a third-first region corresponding to the first region of the capacitance formation portion in the first direction, and a third-second region corresponding to the second region of the capacitance formation portion in the first direction, where the third central region is disposed between the third-first region and the third-second region.

15. The multilayer electronic component according to claim 13, wherein GS1 to GS9 satisfy one or more of GS2>GS1, GS2>GS3, GS5>GS4, GS5>GS6, GS8>GS7, and GS8>GS9.

16. The multilayer electronic component according to claim 13, wherein the side margin portion includes Ti and Mg, an amount of Mg is 0.1 mol or more and 3.0 mol or less relative to 100 mol of Ti.
